(19) United States
(12) Patent Application Publication
(10) Pub. No.: US 2009/0133012 A1
(43) Pub. Date: May 21, 2009

(54) Apparatus and method for providing notification of software update

(75) Inventor: Chun Jung Shih, Taipei City (TW)

Correspondence Address: BACON & THOMAS, PLLC, 625 SLATERS LANE, FOURTH FLOOR, ALEXANDRIA, VA, 22314-1176, US

(73) Assignee: CYBERLINK CORPORATION, Shindian City (TW)

(21) Appl. No.: 11/984,694

(22) Filed: Nov. 21, 2007

(51) Int. Cl. G06F 9/44

(52) U.S. Cl. 717/169

(57) ABSTRACT

Notification of a software update is achieved by multiplexing or otherwise combining data concerning the update with a broadcast signal. The update data may be included in the CA field of a PSIP DTV transport stream.

### BACKGROUND OF THE INVENTION

1. Field of the Invention

This invention relates to a system, method, and apparatus for providing notification of a software update, and in particular to a system, method, and apparatus for providing notification of a software update by multiplexing or otherwise combining metadata concerning the update with a broadcast signal. The invention may utilize an existing broadcasting network, and includes software and/or hardware at both the transmitting and receiving side of the network for adding information concerning the update to the broadcast signal and for recovering the information at the receiving side.

The broadcast signal may, by way of example and not limitation, be a radio or television broadcast signal, such as an MPEG-2 (Moving Picture Experts Group-Ver.2) encoded digital television (DTV) signal, the updates being combined with the video transport stream in a transport multiplexer for subsequent modulation and wireless transmission to a DTV tuner, and the received broadcast signal being demodulated and demultiplexed by a DTV tuner to recover the metadata for recognition by a corresponding software module in the tuner or in a computer connected to the DTV tuner. The update recognizing software module may then notify a user of the availability of the update and/or automatically retrieve the update based on information contained in the metadata.

2. Description of Related Art

a. Problems with Software Update Distribution

As software programs become more complex and product cycles shorter, the need to efficiently provide software updates to users has become ever more critical. Such software updates may be required to eliminate bugs or defects in the original software programs, provide enhanced functionality, and/or fix security vulnerabilities.

Historically, the primary medium for software distribution has been either the traditional floppy disk or the more recent compact disc (CD-ROM). However, more and more individuals are acquiring software by downloading it from remote server computers connected to the client computers through the Internet. Additionally, companies and organizations have begun distributing software to their users across their local area networks. Such network-based software distribution has the advantage that the network cable and supporting communication hardware used to distribute the software are fixed costs associated with the establishment of the network and, therefore, distributing and installing software over an existing network bypasses the costly overhead involved in producing and mailing CD-ROMs or floppy disks. As a result, using a network as a distribution medium reduces the software's total cost of ownership to an extent that cannot be achieved by CD-ROMs or floppies.

A problem with this system of distributing software updates over a network is that software vendors today do not have a good infrastructure to notify users of their application programs about updates to their software, bug fixes, etc., in which case the user might miss critical updates necessary for reliable operation of the software or to eliminate security vulnerabilities. If at the time of registering the software, the user can provide the vendor with an email address, the vendor can use the e-mail address to communicate information about upgrades to the user. However, few people actually register with the vendor, partially out of a concern that their anonymity will not be preserved and the fear of being “spammed” with junk email. Even if the software vendor has a web page that describes the updates, there is no compelling infrastructure that will make the user aware that the web page has changed or let the user know automatically at the time the application is used that an update is available.

As a result, it has become common to provide software, whether distributed over a network or purchased on a CD-ROM, an update module or subroutine that contacts the software vendor through the Internet or, in the case of dcommunications devices such as PDAs or cellphones having Internet browsing capabilities, through a wireless communications network, in order to retrieve information known as metadata that enables the computer or communications device to automatically locate and download updates. The search for updates may be initiated by the user or may be automatically carried out at predetermined times or upon power-up of a computer containing the software to be updated, whereupon downloading of the update may proceed automatically or the user may be given the option of manually initiating an updating process.

This type of automatic update search is effective for software that is used routinely, such as anti-virus software, and in which the updates can be downloaded rapidly. However, if the software is not used as often, critical updates might be missed. In addition, if the update search and download process is likely to be slow, users will often stop the search or turn off the automated update search and/or download and proceed to use the program without updating.

One solution to this problem, disclosed in U.S. Pat. No. 6,353,926, is to use so-called “push” technology by which the vendor sends updates to the user on its own, rather than after a request by the user or the software that needs to be updating. The process calls for the software vendor to provide the option of subscribing to a software update channel at time of purchase. The software update channel is a link to a server through which the user's computer automatically checks for updates, and which downloads software to the user's computer as necessary. After downloading, the user is notified by e-mail or gleaming an icon that an update is available for installation.

However, this solution still suffers from the problem that the user has to subscribe to the “channel,” which users are hesitant to do, and furthermore, has the disadvantage that the user has no option of refusing the software before it is downloaded, wasting disk space if the update is unwanted and possibly leaving the user's computer vulnerable to malicious code if the vendor is not trustworthy, or if the vendor's security is inadequate. Furthermore, this arrangement is not easily adapted to wireless communication networks or other applications that do not use the Internet as the primary source for software and updates, and cannot be used when the user is offline and not connected to the Internet.

In the case of wireless communication devices, it has been proposed instead to provide software updates solely by broadcasting the updates, for example by supplying the software update as short messages transmitted to a wireless telephone handset. However, such transmission of updates in this manner can utilize substantial network resources, are relatively expensive for the user, and of course are not applicable to systems lacking access to a particular wireless network. U.S. Pat. No. 5,896,566 proposes to avoid the problem of cost by having the user query the server about the availability of software and then downloading the software over a separate, less costly medium such as a land line, which avoids the need to carry out expensive downloads over the air, but still requires the user to contact the software provider in order to learn of software availability.

What is needed is a simple method and system of notifying users of software updates that does not require any action on the part of the user such as registration or establishing an update “channel,” thereby preserving the user's anonymity while enabling the software vendor to reach a high percentage of owners of the software for which an update is available, that is applicable to a wide variety of networks and communications media, and that is not limited to a particular updating method following notification.

b. Example of System to which System and Method of Invention may be Applied

As will be described below, the invention solves the above problems by broadcasting information concerning software updates together with regular programming, for retrieval by software at the receiving side of the broadcast. This solution does not involve actually broadcasting the update, but only a notification of the update's availability, and information necessary to retrieve the update through conventional media such as the Internet.

It is intended that the system and method of the invention not be limited to a particular broadcasting network, or to a particular broadcast protocol or format, and further that the system and method of the invention not be limited to a particular method of combining the update data with other data to be broadcast, including program data. As used herein, the term “combining” is intended to refer to data insertion and appending as well as multiplexing.

Those skilled in the art will appreciate that the system and method of the invention may be applied to a variety of different broadcast networks, systems, or protocols that utilize analog as well as digital wireless transmission, cable or satellite networks, and to both television and radio broadcast media and is not to be limited by the type of broadcast media, except in accordance with the appended claims. Nevertheless, the system and method of the invention is especially applicable to a digital television (DTV) broadcast network utilizing the “Program and System Information Protocol” (PSIP) with “conditional access” (CA), illustrated in FIGS. 1-2, since the update data can be included in the conditional access field.

PSIP is an especially versatile broadcast protocol that is designed to be compatible with conventional analog (e.g., NTSC) broadcasting as well as digital broadcasts. FIG. 1 shows a DTV broadcasting system that provides for PSIP a 6 MHz RF channel that occupies the same bandwidth as a conventional television broadcast.

At the receiving end, the DTV system to which the present invention may be applied includes, as shown in FIG. 2, a DTV tuner 10 and 8-VSB demodulator 11, which supplies the demodulated transport stream to transport demultiplexer 12. Transport demultiplexer 12 recovers the MPEG-2 video bitstream, the AC-3 audio bitstream, and the PSIP data as well as clock and synchronization data and time stamps. The PSIP data is supplied to a program guide database module 13 for controlling the tuner in response to program selections by the user, while the video and audio bitstreams are supplied to single-program decoder 14, which includes MPEG-2 video decoder 15, AC-e audio decoder 16, clock recovery and audio/visual (A/V) synchronization module 17, and display processing module 18.

In the preferred embodiments that utilize the system of FIGS. 1 and 2, the metadata containing update information may be added to the broadcast signal via either first multiplexer 5 or second multiplexer 6, and supplied by an appropriate hardware device or software module to the user's computer, cellular telephone, PDA or other device at the receiving end. It is generally most conveniently, however, to add the metadata using the second transport multiplexer 6 so as to eliminate the need for modification of the single-program encoder and decoder. The PSIP broadcast stream includes an extension field to which the update data may easily be added. On the other hand, it is also possible to add the update data to the PSIP data, or even the video and/or audio data, depending on the exact format used so that the update data has already been inserted, combined, or appended to other data before the other data is added to the other data by multiplexing. If the system and method of the invention is applied to a different type of broadcast network, then the multiplexer may of course be replaced by other types of data insertion, combining, or appending software or hardware.

### SUMMARY OF THE INVENTION

It is accordingly a first objective of the invention to overcome the disadvantages of the prior art by providing a system and method for notifying a user of software updates that does not require the user to subscribe to an update service or to formally register the software.

It is a second objective of the invention to provide a system and method for notifying a user of software updates that permits a vendor to reach a wide audience without the need for e-mail lists or other action on the part of the recipient, and which requires minimal resources and/or bandwidth.

It is a third objective of the invention to provide a system and method for notifying a user of software updates that can utilize a wide variety of broadcast media, and to make the updates available even when the user is not “on-line.”

It is a fourth objective of the invention to provide a system and method for notifying a user of software updates that does not depend on the particular media over which the software is to be delivered.

These objectives are achieved, in accordance with the principles of a preferred embodiment of the invention by providing a system and method for notifying a user of the availability of software updates in which the notification is appended to or combined with a regular broadcast program, such as a radio or television program, the metadata being recovered by a broadcast receiver at the location of the user and supplied to the user's computer or communications device for use in carrying out a subsequent update.

In an especially preferred embodiment of the invention, the notification is in the form of metadata that identifies the update and provides a link to the server. As a result, the software may be updated automatically or the owner of the software to be updated can connect to the server at the owner's convenience and discretion.

Those skilled in the art will appreciate that the invention involves hardware and/or software at both the transmission and receiving ends of a broadcast. For example, the invention requires the addition of an update metadata generator on the transmission side, and an update recognition module on the receiving side, both the metadata generator and recognition module being implementable in the form of hardware, software, or a combination of hardware and software. Further, a receiver that includes hardware or software for retrieving update metadata may be adapted for use with different broadcast protocols, and be manufactured and sold separately and independently of the hardware/software at the transmitting end for adding the update metadata to a broadcast.

### BRIEF DESCRIPTION OF THE DRAWINGS

FIG. 1 is a block diagram of a conventional PSIP generation and insertion system to which the system and method of the invention may be applied, in accordance with the principles of a preferred embodiment of the invention.

FIG. 2 is a block diagram of a conventional PSIP receiver for use with the system of FIG. 1.

FIG. 3 is a block diagram of a system for notifying a user of the availability of software updates according to a preferred embodiment of the invention.

FIG. 4 is a block diagram of a receiver for use in connection with the notification system of FIG. 3.

FIG. 5 is a flowchart of a software update notification method according to a preferred embodiment of the invention.

### DETAILED DESCRIPTION OF THE PREFERRED EMBODIMENTS

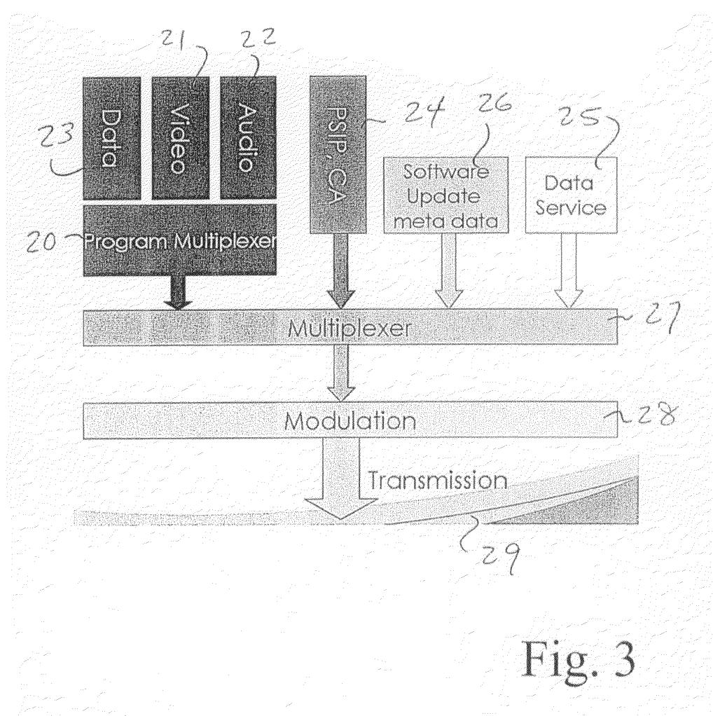

FIG. 3 shows a system for notifying a user of software updates in accordance with the principles of a preferred embodiment of the invention. As illustrated in FIG. 3, the system includes a program multiplexer 20 for combining video data 21, audio data 22, and other data 23 into a television signal. The television signal is in turn combined with Program and System Information Protocol (PSIP) data 24 such as station, schedule, V-chip and other information specified in ATSC standards, to the signal. The PSIP data may provide a conditional access (CA) descriptor that allows the broadcaster to field pay services accessible upon authentication, with the update data being in that case conveniently provided in the conditional access field. In addition, the multiplexer is connected to a data service 25 that can be used to provide data other than the “PSIP” data.

Those skilled in the art will appreciate that video and audio sources 21 and 22, and program multiplexer 24, may correspond to encoders 3 and 4 and program multiplexer 5 of the DTV system of FIG. 1. Alternatively, any of the video, audio, or data sources, as well as the program multiplexer may be deleted in favor of a different video and/or audio source, including conventional or non-DTV program sources incompatible with PSIP information, so long as the broadcast program source can be combined with software update metadata, as described below.

In addition, those skilled in the art will appreciate that while the multiplexer 27, modulation 28, and transmitter 29 may correspond to multiplexer 6, modulator 7, and transmitter 8 of FIG. 1, the invention is not to be limited to any particular data combining arrangement and/or modulator or transmitter since the principles of the invention are not limited to PSIP broadcasting, or even DTV. For example, the modulation may be analog modulation, and the configuration of the sources and multiplexers may be varied in numerous ways. Of course, PSIP data may be omitted even if a DTV system is used, or the PSIP data may be provided without the CA descriptor.

A key feature of the present invention is the inclusion of software update metadata generator 26 for generating metadata related to software updates. The metadata generator may be connected directly to the multiplexer, or the data server, may be connected to a separate multiplexer for combining with the output of the data server, or to a multiplexer that is between the ATSC multiplexer and the modulation equipment. For applications utilizing the DTV system of FIG. 1, the metadata generator 26 may be connected to the line labeled “Data” that also supplies data to the program encoder and PSIP generator, with the update data being included in an extension field in the MP transport stream. Any hardware and/or software configuration that enables the metadata to be added to the broadcast signal will fall within the scope of the present invention.

In the preferred embodiment, the metadata is simply information on the location of a software update, and data necessary to identify the update. The format of the metadata will depend on the medium used to download the data, and will differ for example between information on downloads from a server via the Internet and downloads over a wireless network. An example of metadata in a suitable format for addition to the DTV signal of FIG. 3 and that provides information that may be used to retrieve data over the Internet, is as follows:

<UpdateInfo>
<ApID>
<CurrentVersion>
3.0.4927
</CurrentVersion>
<TargetVersion>
3.1.5012
</TargetVersion>
<ExpireWhen>
20070930
</ExpireWhen>
<TargetURL>
ehttp://www.clsupport.com/upgrade/uid-a48f122a.htm
</TargetURL>
<UpdateInfo>

The listed metadata includes identifiers for the current and target or updated versions of the software (respectively, 3.0.4927 and 3.1.5012), an expiration date (Sep. 30, 2007), and a location of the update. Those skilled in the art will appreciate that the location of the update is a URL. Those skilled in the art will note that the letter e has been added before http to comply with Patent Office rules prohibiting the creation of hyperlinks in patent specifications. On the other hand, if the update is to be downloaded over a wireless communications network, the metadata might include a telephone number.

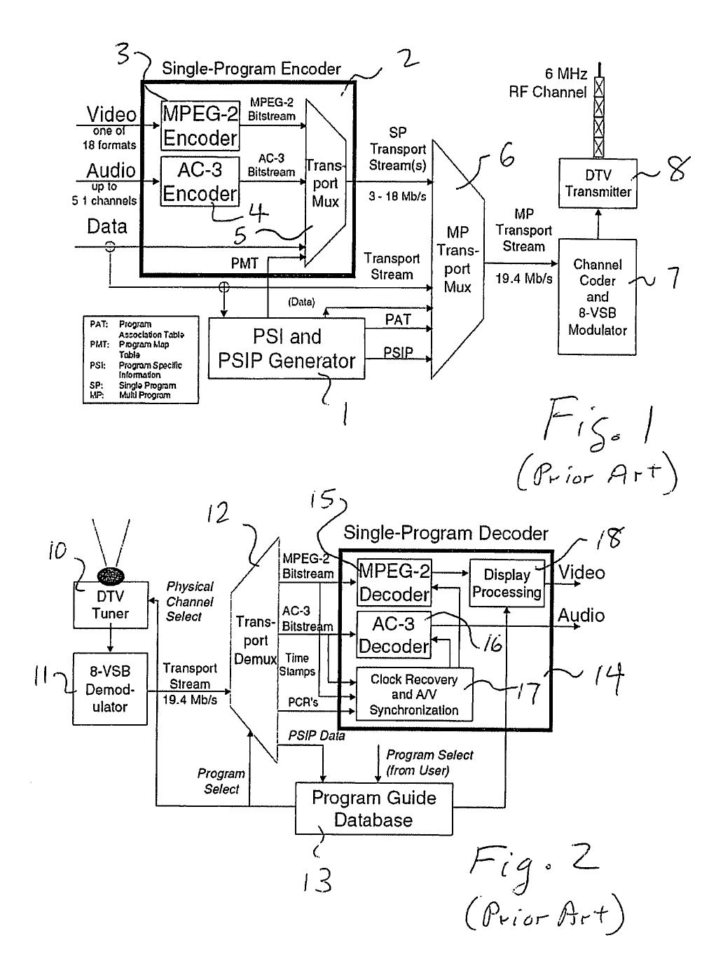

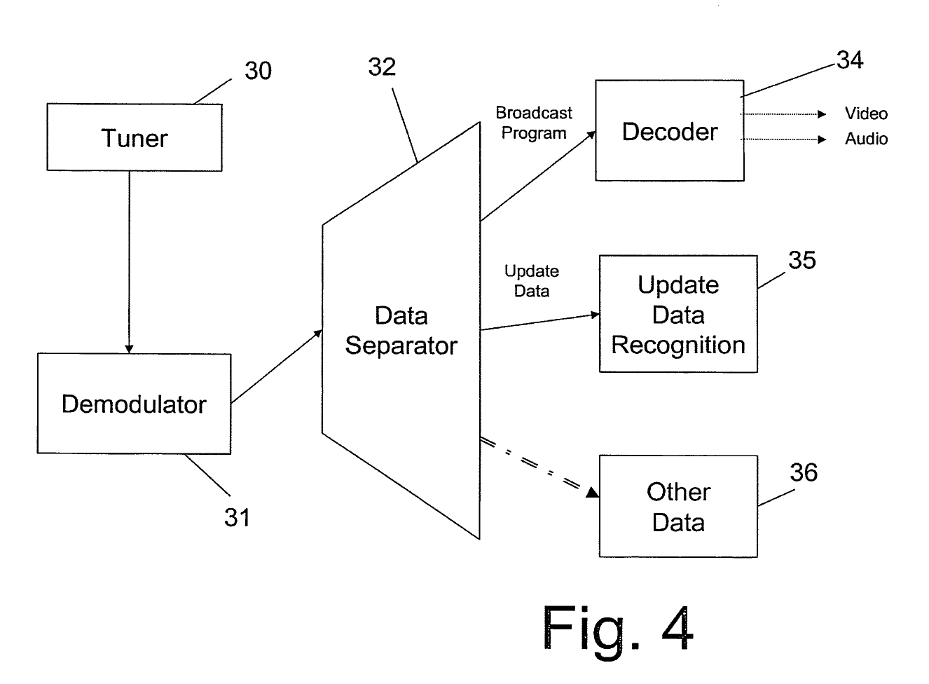

FIG. 4 is a block diagram illustrating the receiving end of the system illustrated in FIG. 3. As shown in FIG. 4, the broadcast signal is received by a tuner 30, which may correspond to tuner 10 of FIG. 2, and is demodulated by a demodulator 31, which may correspond to demodulator 11 of FIG. 2. Alternatively, the tuner and demodulator may be a conventional television receiver, cable box, or satellite receiver. The demodulated broadcast signal is supplied to a demultiplexer 32 or other circuitry for separating the software update metadata from the demodulated broadcast signal, and the metadata is supplied to a personal computer, router, or other device 33 including software for recognizing the metadata and either generating a message that an update is available or initiating retrieval of the software over an appropriate medium such as the Internet or a telephone network. Demultiplexer 32 also supplies the demultiplexed television or radio program to a program decoder 24, which may be a DTV decoder corresponding to decoder 14 of FIG. 2 if the demultiplexer corresponds to demultiplexer 12 of FIG. 2. In that case, PSIP data may be supplied to a program guide database corresponding to database 13 of FIG. 2.

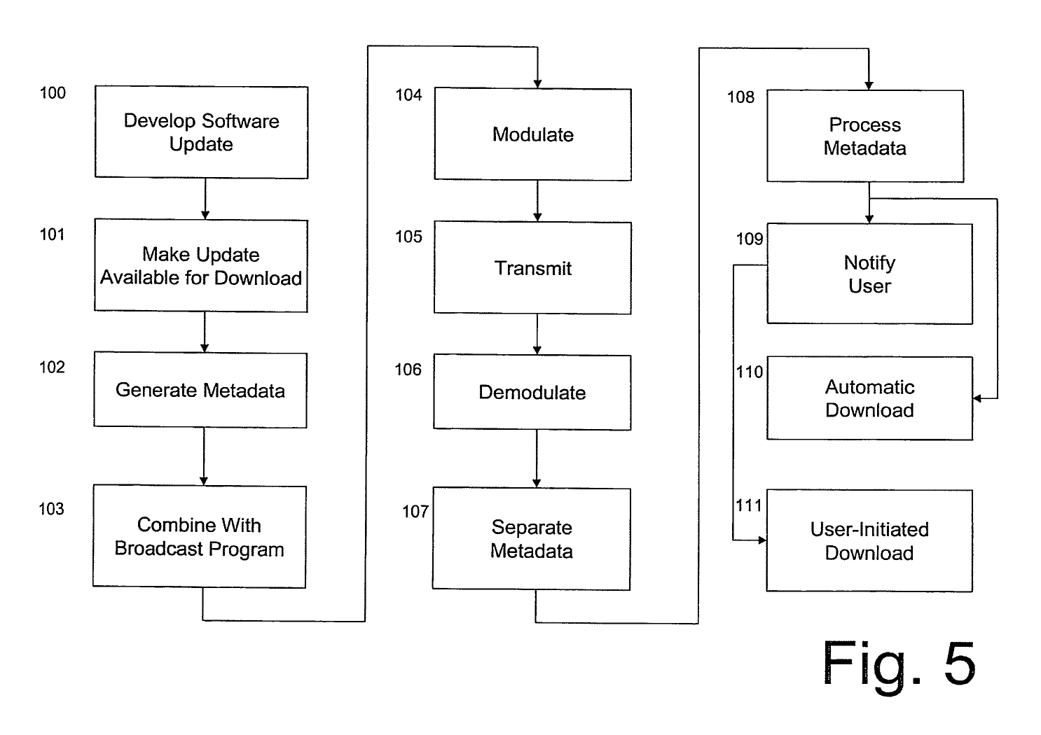

FIG. 5 shows a software update method according to a preferred embodiment of the invention. As illustrated in FIG. 5, upon development of a software update (step 100), the software vendor makes the update available to purchasers or the original software by assigning a location, such as the IP address of a server, and a name to the update (step 101) and generates corresponding metadata including at least the location, name of the update, and name of the software to be updated (step 102). The metadata is then combined with a broadcast program (step 103). By way of example and not limitation, the combination may be carried out by the transport multiplexer of a DTV system such as the one shown in FIG. 2. Upon combination of the metadata and the broadcast program, the combined metadata and broadcast program are supplied to a modulator to generate a signal suitable for transmission (step 104), and then supplied to the transmitter (step 105).

In order to reach as many customers of the software as possible, the metadata may be combined with, inserted into, or appended to a variety of different broadcast programs, and transmitted at different times with the different programs. Alternatively, if the metadata does not take much bandwidth, it may simply be continuously added to the broadcast transmission over an extended period, if necessary until a new update becomes available. The software module at the receiving end can be adapted to ignore any metadata that it has already recognized.

At the receiving end, the broadcast program is supplied to a demodulator by an appropriate tuner (step 106), which may be a DTV tuner, after which the metadata is separated from the broadcast program (step 107), and the metadata is processed by appropriate software in a computing device, communications device, or the like (step 108). The user is then notified of the update (step 109) and the user initiates an update procedure involving retrieval and installation of the update (step 110) or the metadata is used to initiate an automatic update procedure (step 111) without user intervention, and with or without notification of the user, thereby completing the preferred method.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention. It is therefore intended that the invention not be limited by the above description or accompanying drawings, but that it be defined solely in accordance with the appended claims.

What is claimed is:

1. A system for providing notification of a software update, comprising:
an update data generator for generating data concerning the update, said update data generator being connected to a combining device for combining the data with, inserting the data into, or appending the data to a broadcast program;
a modulator connected to the combining device for converting the broadcast program having combined, inserted, or appended data into a broadcast program signal;
a transmitter for transmitting the broadcast program signal;
a receiver including a tuner and demodulator for receiving and demodulating the broadcast program signal and separating the broadcast program from the data;
a device or software for recognizing that the data is data that concerns availability of a software update.

2. A system as claimed in claim 1, wherein the update data generator generates metadata including a location of the software update, an identifier of the software update, and an identifier of the data to be updated.

3. A system as claimed in claim 2, wherein the location of the software update is indicated by an Internet Uniform Resource Locator (URL).

4. A system as claimed in claim 1, wherein the location of the software update is indicated by a telephone number.

5. A system as claimed in claim 1, wherein the data combiner is a multiplexer.

6. A system as claimed in claim 1, wherein the broadcast program is a DTV program and wherein the data combiner is a transport multiplexer arranged to combine a DTV transport stream, PSIP data, and said data concerning said software update.

7. A system as claimed in claim 6, wherein said PSIP data includes a conditional access (CA) field and said update data is included in the conditional access field.

8. A system as claimed in claim 6, wherein said modulator is a channel coder and VSB modulator, and wherein said transmitter is a DTV transmitter.

9. A system as claimed in claim 1, wherein said receiver includes a DTV tuner, demodulator, and transport demultiplexer.

10. A system as claimed in claim 9, wherein said demultiplexer separates a demodulated said broadcast signal into MPEG-2 and AC-3 bitstream, PSIP data, and said update data.

11. Apparatus for broadcasting notification of a software update, comprising:
an update data generator for generating data concerning the update, said update data generator being connected to a combining device for combining the data with, inserting the data into, or appending the data to a broadcast program;
a modulator connected to the combining device for converting the broadcast program having combined, inserted, or appended data into a broadcast program signal; and
a transmitter for transmitting the broadcast program signal containing said broadcast program and said update data.

12. Apparatus as claimed in claim 11, wherein the update data generator generates metadata including a location of the software update, an identifier of the software update, and an identifier of the data to be updated.

13. Apparatus as claimed in claim 12, wherein the location of the software update is indicated by an Internet Uniform Resource Locator (URL).

14. Apparatus as claimed in claim 11, wherein the location of the software update is indicated by a telephone number.

15. Apparatus as claimed in claim 11, wherein the data combiner is a multiplexer.

16. Apparatus as claimed in claim 11, wherein the broadcast program is a DTV program and wherein the data combiner is a transport multiplexer arranged to combine a DTV transport stream, PSIP data, and said data concerning said software update.

17. Apparatus as claimed in claim 16, wherein said PSIP data includes a conditional access (CA) field and said update data is included in the conditional access field.

18. Apparatus as claimed in claim 16, wherein said modulator is a channel coder and VSB modulator, and wherein said transmitter is a DTV transmitter.

19. Apparatus for receiving and recognizing notification of a software update, comprising:
a receiver including a tuner and demodulator for receiving and demodulating a broadcast program signal containing a broadcast program and update data concerning availability of a software update, the receiver being arranged to demodulate the broadcast program signal and to separate the broadcast program from the update data;
a device or software for recognizing that the update data is data that concerns availability of a software update.

20. Apparatus as claimed in claim 19, wherein said receiver includes a DTV tuner, demodulator, and transport demultiplexer.

21. Apparatus as claimed in claim 20, wherein said demultiplexer separates a demodulated said broadcast signal into MPEG-2 and AC-3 bitstream, PSIP data, and said update data.

22. A method of providing a notification of a software update, comprising the steps of:
generating data concerning a software update;
combining the data with a broadcast program;
modulating the broadcast program and combined data to obtain a broadcast signal; and
broadcasting the broadcast signal.

23. A method as claimed in claim 22, further comprising the steps of:
a receiver receiving and demodulating the broadcast signal and separating the data from the broadcast program;
software or a device recognizing the data as software update data.

24. A method as claimed in claim 22, further comprising the step of, upon recognizing the data as software update data, notifying a user that a software update is available.

25. A method as claimed in claim 22, further comprising the step of, upon recognizing the data as software update data, establishing a connection to a server and downloading the software update based on the data.

26. A method as claimed in claim 22, wherein the data is metadata including a location of the software update, an identifier of the software update, and an identifier of the data to be updated.

27. A system as claimed in claim 26, wherein the location of the software update is indicated by an Internet Uniform Resource Locator (URL).

28. A system as claimed in claim 26, wherein the location of the software update is indicated by a telephone number.

29. A system as claimed in claim 22, wherein the step of combining the data with a broadcast program comprises the step of multiplexing the data with broadcast program data.

30. A system as claimed in claim 29, wherein the broadcast program is a DTV program and wherein the multiplexing step multiplexes a DTV transport stream, PSIP data, and the data concerning said software update.

31. A system as claimed in claim 30, wherein said PSIP data includes a conditional access (CA) field and said update data is included in the conditional access field.
